(19) United States
(12) Patent Application Publication
(10) Pub. No.: US 2004/0075757 A1
(43) Pub. Date: Apr. 22, 2004

(54) Image retrieval system and method for processing image in image retrieval system

(76) Inventors: Chen-Liang Huang, Taichung (TW); Chih-Yi Huang, Taichung (TW); Chung-Yi Cheng, Taichung (TW); Cheng-Huei Chiang, Taichung (TW)

Correspondence Address: BIRCH STEWART KOLASCH & BIRCH, PO BOX 747, FALLS CHURCH, VA, 22040-0747, US

(21) Appl. No.: 10/446,111

(22) Filed: May 28, 2003

(30) Foreign Application Priority Data
Oct. 17, 2002 (TW) 91123919

(51) Int. Cl. H04N 5/262

(52) U.S. Cl. 348/239

(57) ABSTRACT

The present invention provides an image retrieval system and method for processing image in an image retrieval system. The image retrieval system automatically detects the shooting angle and regulates an output image according to the shooting angle. The present invention includes a level-detecting unit and an image-processing unit. The level-detecting unit detects a rotation direction and an angle of the bottom plane relative to the ground. The image-processing unit rotates the input image by a value of the angle to generate an output image.

### CROSS REFERENCE TO RELATED APPLICATIONS

This Application claims priority to Taiwan Patent Application No. 091123919 entitled “Image Retrieval System and Method for Processing Image in Image Retrieval System”, filed Oct. 17, 2002.

### FIELD OF THE INVENTION

The present invention relates to an image retrieval system and method for processing image in image retrieval system, and more particularly, to an image retrieval system and method for processing image in image retrieval system which automatically detects shooting angle.

### BACKGROUND OF THE INVENTION

As the number of users of portable electronic device increases in recent years, the market of digital cameras expands rapidly as well. In order to survive in market competition, many manufacturers pay theirs attention to develop new digital cameras.

The typical digital cameras do not automatically detect the rotation angle between the camera bottom plane and the ground when shooting images. As shown in FIG. 1, a user perpendicularly shoots an object 90 by rotating a digital camera 100 by 90 degrees. For the user, the image in the digital camera screen 120 is perpendicular (horizontal pixel number is less than vertical pixel number). However, the digital camera 100 stores the image in a transverse format (horizontal pixel number is greater than vertical pixel number). Since the output image 210 displayed on the monitor 200 is transverse-wise, the user has to use image-processing software to rotate the image perpendicular-wisely. Extra procedures bring the user inconveniences.

### SUMMARY OF THE INVENTION

In view of the disadvantage of prior art, the present invention provides an image retrieval system for simplifying the image processing after detecting the shooting angle to adjust the output image.

The image retrieval system includes a level-detecting unit and an image-processing unit. The level-detecting unit detects a rotation direction and an angle of bottom plane relative to the ground. The image-processing unit processes the input image according to the direction and the angle. The image-processing unit rotates the input image by a value of the angle to generate an output image.

The retrieval system may rotate clockwise or counterclockwise. The angle of the bottom plane relative to the ground may be 90, 180, or 270 degrees. The output image has a reference level parallel to the ground.

The present invention also provides an image-processing method for a system retrieving an input image. The present invention first detects a rotation direction and an angle of the bottom plane relative to the ground. Then, the present invention processes an input image according to the direction and the angle to generate an output image.

### BRIEF DESCRIPTION OF THE DRAWINGS

FIG. 1 shows the output image obtained from the image retrieval system of prior art when user shots an object.

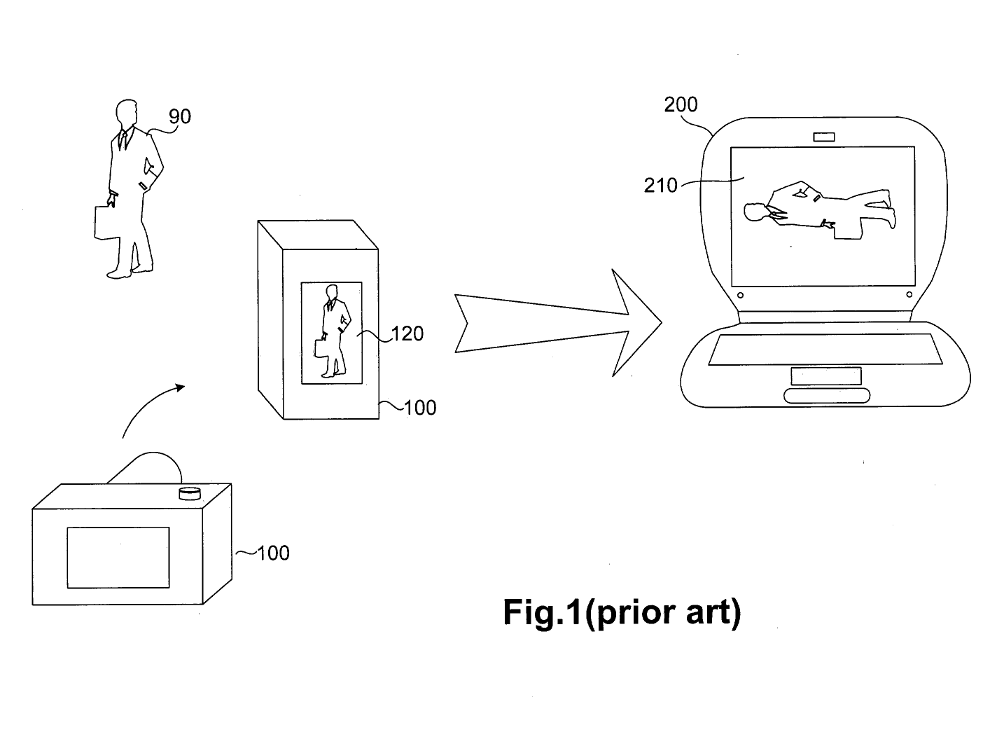

FIG. 2 shows an exemplary embodiment of the present invention.

FIG. 3 shows a level-detecting unit of the present invention.

FIG. 4 shows the output image obtained from the present invention when user rotates the image retrieval system of the present invention.

FIG. 5 shows the flow chart of the image-processing method of the present invention.

### DETAILED DESCRIPTION OF THE INVENTION

The present invention provides an image retrieval system which may be digital cameras, digital video (DV), digital 8 mm (D8), etc.

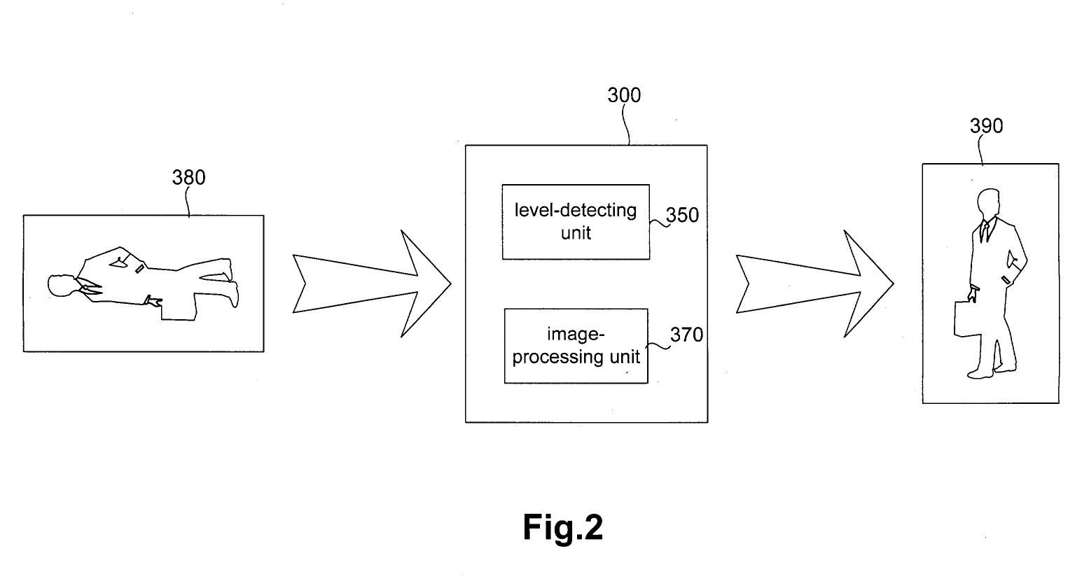

The image retrieval system 300 includes a level-detecting unit 350 and an image-processing unit 370 as shown in FIG. 2. The level-detecting unit 350 detects a rotation direction and an angle of bottom plane relative to the ground when the image retrieval system retrieves an input image 380. The image retrieval system 300 has a lens axis. The retrieval system 300 rotates along the lens axis. The retrieval system 300 may rotate clockwise or counterclockwise. In this embodiment, the angle of the bottom plane relative to the ground may be 90, 180, or 270 degrees.

Further, the image-processing unit 370 processes the input image according to the rotation direction and the angle. The image-processing unit 370 rotates the input image by a value of the angle to generate an output image 390. The output image 390 has a reference level parallel to the ground.

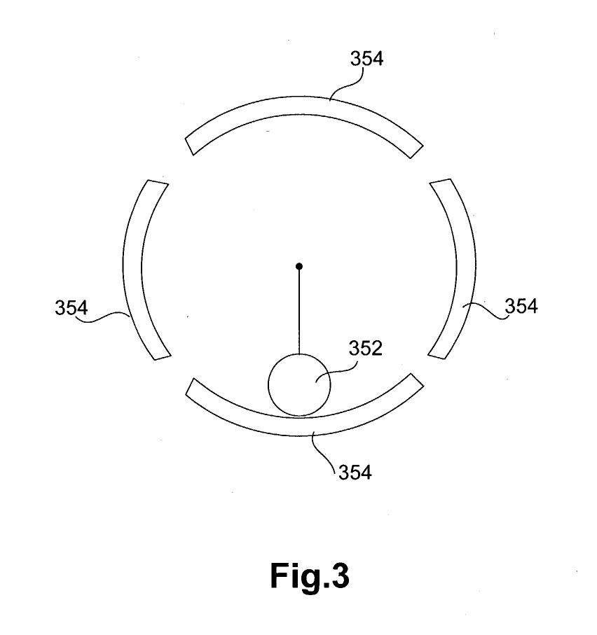

FIG. 3 shows an embodiment of the level-detecting unit 350 which uses gravity, mechanical components, and/or circuits to detect the rotation direction and angle of bottom plane of image retrieval system relative to the ground. The embodiment shown in FIG. 3 includes a metal pendulum 352 and conductors 354 having different angles relative to the ground. When the image retrieval system 300 rotates along the lens axis by an angle of the bottom plane relative to a reference ground, the pendulum 352 droops due to the gravity and contacts with one of conductors. Then, the level-detecting unit 340 obtains the rotation direction and angle of bottom plane of image retrieval system relative to the ground. Alternatively, the level-detecting unit 350 may be a sensor.

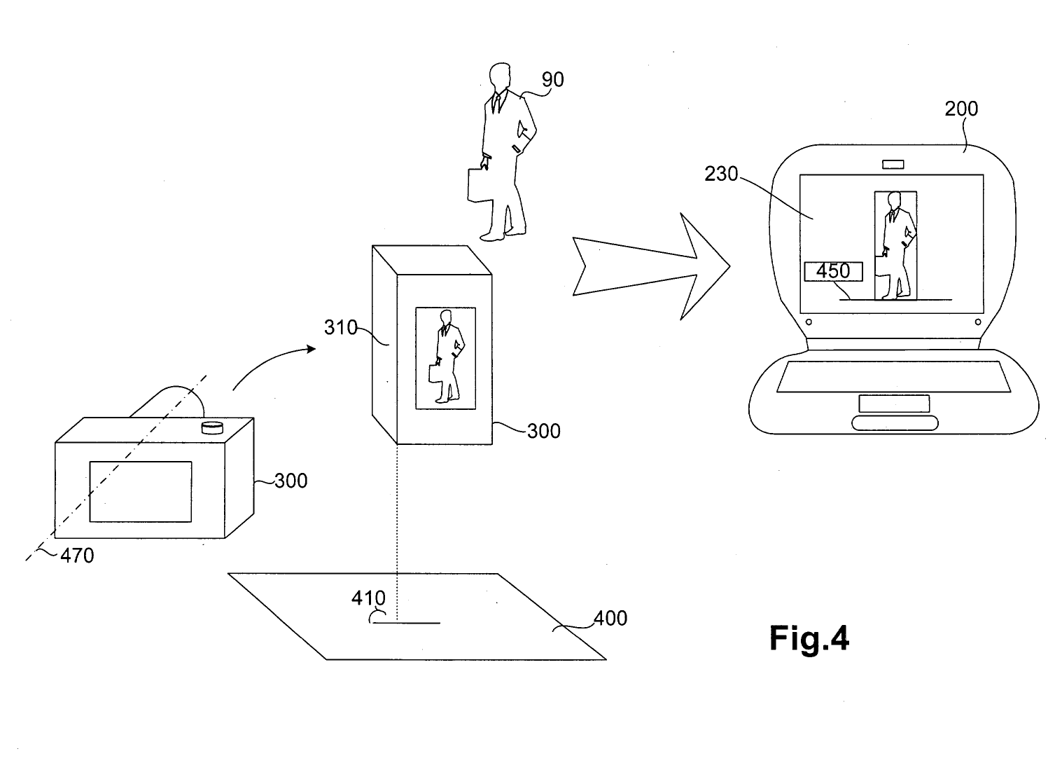

When the user clockwise rotates the image retrieval system 300 along the lens axis 470 by 90 degrees to retrieves image 90 as shown in FIG. 4, the level-detecting unit 350 detects the rotation direction and angle 410 of bottom plane 310 relative to the ground 400. In this embodiment, the angle is 90 degrees.

Further, after clockwise-rotating the input image 380 by 90 degrees, the image-processing unit 370 generates an output image 230 in a perpendicular format. When being displayed on the computer screen of the computer 200, the reference level 450 of the output image 230 is parallel to the ground 400.

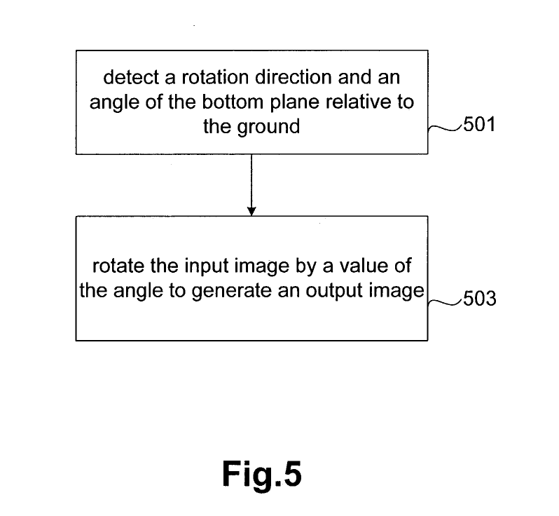

The present invention also provides an image-processing method for a system retrieving an input image. The image retrieval system has a bottom plane and is rotatable relative to a reference ground. As shown in FIG. 5, the method first detects a rotation direction and an angle of the bottom plane relative to the ground (step 501). The image retrieval system rotates along a lens axis clockwise or counterclockwise. And the angle of the bottom plane relative to the ground may be 90, 180, or 270 degrees.

Then, the method processes the input image according to the rotation direction and the angle. For instance, the present invention rotates the input image by the value of the angle to generate the output image (step 503). The output image has a reference level parallel to the ground.

While this invention has been described with reference to an illustrative embodiment, this embodiment is not intended to be construed in a limiting sense. Various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

1. An image retrieval system for retrieving an input image, said image retrieval system having a bottom plane and being rotatable relative to a reference ground, comprising;
a level-detecting unit for detecting a rotation direction and a angle of the bottom plane relative to the ground; and
an image-processing unit for generating an output image by processing said input image according to said rotation direction and said angle.

2. The image retrieval system of claim 1, wherein said image-processing unit rotates said input image by a value of said angle to generate said output image.

3. The image retrieval system of claim 1, further comprising a lens axis, said image retrieval system rotating along said lens axis.

4. The image retrieval system of claim 1, wherein said output image has a reference level parallel to said ground.

5. The image retrieval system of claim 1, wherein said direction is a clockwise direction.

6. The image retrieval system of claim 1, wherein said direction is a counterclockwise direction.

7. The image retrieval system of claim 1, wherein said angle is 90 degrees.

8. The image retrieval system of claim 1, wherein said angle is 180 degrees.

9. The image retrieval system of claim 1, wherein said angle is 270 degrees.

10. An image-processing method for a image retrieval system retrieving an input image, said image retrieval system being rotatable relative to a reference ground, comprising:
detecting a rotation direction and a angle of the bottom plane relative to the ground; and
generating an output image by processing said input image according to said rotation direction and said angle.

11. The method of claim 10, wherein processing said input image according to said rotation direction and said angle further comprises rotating said input image by a value of said angle to generate said output image.

12. The method of claim 10, wherein said image retrieval system comprises a lens axis, said image retrieval system rotating along said lens axis.

13. The method of claim 10, wherein said output image has a reference level parallel to said ground.

14. The method of claim 10, wherein said direction is a clockwise direction.

15. The method of claim 10, wherein said direction is a counterclockwise direction.

16. The method of claim 10, wherein said angle is 90 degrees.

17. The method of claim 10, wherein said angle is 180 degrees.

18. The method of claim 10, wherein said angle is 270 degrees.
